(19) United States
(12) Patent Application Publication
(10) Pub. No.: US 2026/0054332 A1
(43) Pub. Date: Feb. 26, 2026

(54) METHOD FOR ASSEMBLING SUB-ASSEMBLIES, METHOD FOR ASSEMBLING A MULTICOMPONENT ITEM, ASSEMBLY STATION AND ASSEMBLY LINE

(71) Applicant: COSBERG S.P.A., Terno d'Isola (Bergamo) (IT)

(72) Inventor: Gianluigi Carlo VISCARDI, Terno d'Isola (Bergamo) (IT)

(21) Appl. No.: 19/103,540

(22) PCT Filed: Aug. 9, 2023
(86) PCT No.: PCT/IB2023/058038

§ 371 Date: Feb. 12, 2025

(30) Foreign Application Priority Data
Aug. 18, 2022 (IT) 102022000017406

(51) Int. Cl. B23P 19/04; B21J 15/02; B23P 21/00

(52) U.S. Cl. CPC B23P 19/04; B21J 15/02; B23P 21/004

(57) ABSTRACT

A method for assembling two sub-assemblies involves providing a first sub-assembly and a second sub-assembly, by a first manipulator arm and a second manipulator arm, picking the first sub-assembly and the second sub-assembly, keeping the first and second sub-assemblies suspended, bringing the first and second sub-assemblies to a mutual assembly position and assembling the first and second sub-assemblies in a suspended-in-air position to form a joint assembly, avoiding all contact with any support other than the first and second manipulator arms. A method for assembling multicomponent items including the method for assembling the two sub-assemblies is provided. An assembly station and an assembly line including the assembly station are also provided.

### DESCRIPTION

### FIELD OF APPLICATION

The present invention relates to a method for assembling sub-assemblies, a method for assembling multicomponent items, an assembly station, and an assembly line. The present invention is applied, in particular but not exclusively, in the assembly of hinges for furniture doors.

In the field of plants for assembling multicomponent items, it is necessary for the machines to be capable of manufacturing increased volumes in a short time. Indeed, only in the presence of such features may be the cost of the plant be amortized in a short time and the investment be remunerative.

Therefore, in the field of manufacturing machines for such plants, the tendency exists to create increasingly fast lines, at times capable of manufacturing tens of thousands of items a day.

It is thus essential to improve the individual assembly stations of a line so as to optimize the assembly processes in each station to obtain improved productivity of the individual station, which has a positive effect on the production capacity of the entire line.

Disadvantageously, assembly lines for multicomponent items of the background art do not allow achieving increased levels of productivity, which are required today to meet the current market needs.

Moreover, disadvantageously assembly stations for multicomponent items of the background art are capable of performing one assembly operation alone for each stationary status, where stationary status means the status in which the receiving component, e.g., the wing of a hinge, preferably placed on a grabbing device (e.g., a pallet or a laying base) remains available for a same assembly station without undergoing operations and/or moving. In other words, the stationary status of a component (and hence preferably also of the related grabbing device) indicates the same remaining in the same assembly station.

For example, without losing in generality, in the stationary status, the component actually remains stationary in the assembly station, for example when this is placed on a pallet which slides along an assembly line, and stops close to the station, or it is kept in movement, for example, when the receiving component is placed on a rotary table or on a laying station, but it remains in the same assembly status.

Therefore, known assembly lines generally provide several series of individual assembly stations, each being associated with a respective stationary status in which the component receives in assembly one single component at a time and is involved in each assembly operation.

This disadvantageously affects the length of the assembly line and the use of excessive resources to create each station, with apparent disadvantages in terms of overall volumes within the production sites, clearly in addition to the production times of each individual multicomponent item which must cross many stations before being terminated.

### SOLUTION OF THE INVENTION

Therefore, the need is strongly felt to provide an assembly method, an assembly station and an assembly line for multicomponent items capable of overcoming the drawbacks typical of the background art and which meet the production needs of the industry.

In particular, it is an object of the present invention to accelerate the assembly operations of a multicomponent item, e.g., a hinge.

Moreover, it is the object of the present invention to also simplify the assembly operations so as to increase the production volumes, time of the multicomponent item assembly stations according to the background art being equal.

It is a further object of the present invention to increase the flexibility of the line, i.e., to adapt the assembly line quickly and automatically to construction variants of the multicomponent item, thus only affecting the sub-steps of the assembly, without acting on the development of the main line.

Such a need is met by a method for assembling sub-assemblies, by a method for assembling multicomponent items, by an assembly station and by an assembly line according to the appended independent claims. The claims dependent thereon describe preferred or advantageous embodiments of the invention, involving further advantageous aspects.

### DESCRIPTION OF THE DRAWINGS

The features and advantages of the present invention will become however apparent from the following description of some preferred embodiments thereof, given by way of non-limiting indication, with reference to the accompanying drawings, in which:

FIG. 1 shows a perspective view of a multicomponent item according to an embodiment of the present invention, in which the multicomponent item is a hinge;

FIG. 2a shows a perspective view of a multicomponent item according to an embodiment of the present invention, in which a rivet in insertion position is shown;

FIG. 2b shows the same perspective view of the component item FIG. 2a, in which the rivet is shown in inserted position;

FIG. 3 shows a perspective view of a joint assembly for a multicomponent item according to an embodiment of the present invention;

FIG. 4a shows a first sub-assembly for assembling a joint assembly in an embodiment of the present invention;

FIG. 4b shows a second sub-assembly for assembling a joint assembly in an embodiment of the present invention;

FIG. 5 shows an exploded view of the components (a, b, c, d) forming the joint assembly according to the example in FIG. 3, and of a rivet (e) suitable for connecting said joint assembly in an articulated manner together with a receiving component to form a multicomponent item in an embodiment of the present invention;

FIG. 6a shows a side elevation view of a first sub-assembly and a second sub-assembly assemblable with each other to form a joint assembly, in an embodiment of the present invention;

FIG. 6b shows a side elevation view of a joint assembly in assembled format, comprising the sub-assemblies in FIG. 6a;

FIG. 7 shows a diagrammatic perspective view of a grabbing device on which a receiving component according to an embodiment of the present invention is housed;

FIG. 8 shows a diagrammatic perspective view of a grabbing device on which a previously assembled multicomponent item is housed, in an embodiment of the present invention;

FIG. 9 shows a diagrammatic perspective view of an assembly station comprising a first and second manipulator arm according to an embodiment of the present invention, in which the first sub-assembly and the second sub-assembly are in mutual assembly position;

a FIG. 10 shows a front elevation view of an enlargement of the assembly station in FIG. 9;

FIG. 11 shows a perspective view of an assembly station according to an embodiment of the present invention, in which the first and second sub-assemblies are assembled to form a joint assembly and are in suspended-in-air position;

FIG. 12 is a front elevation view of the assembly station in FIG. 11;

FIG. 13 is a perspective enlargement view of an assembly station according to an embodiment of the present invention;

FIG. 14a shows a front view of a first sub-assembly and a second sub-assembly in suspended-in-air position above a grabbing device carrying a receiving component, according to an embodiment of the present invention, in which said first and second sub-assemblies are in a mutual assembly position;

FIG. 14b shows the same embodiment depicted in FIG. 14a, in which said first and second sub-assemblies are in assembled position and form a joint assembly;

FIG. 15 shows a perspective view of an assembly station according to an embodiment of the present invention, comprising a riveting apparatus;

FIG. 16 shows an enlarged perspective view of the assembly station in FIG. 15;

FIG. 17 shows a perspective assembly view of an assembly station according to an embodiment of the present invention;

FIG. 18 shows a perspective view of a first pre-assembly group of an assembly station according to an embodiment of the present invention;

FIG. 19 shows an enlarged detailed view of a portion of the first assembly group in FIG. 18, showing, in particular, a third manipulator arm, a rotary table and a greasing station of the first pre-assembly group;

FIG. 20a shows a perspective view of a third manipulator arm according to an embodiment of the present invention;

FIG. 20b shows a front view of the third manipulator arm in FIG. 20a;

FIG. 21 shows an enlarged perspective view of a greasing station of the first pre-assembly group according to an embodiment of the present invention;

FIG. 22 shows a perspective view of a rotary table of the first pre-assembly group according to an embodiment of the present invention;

FIG. 23 shows a perspective view of a second pre-assembly group of an assembly station according to an embodiment of the present invention;

FIG. 24 shows a front view of a portion of the first pre-assembly group which shows a second manipulator arm according to an embodiment of the present invention.

### DETAILED DESCRIPTION

With reference to the aforesaid drawings, reference numeral 9 indicates as a whole an assembly station 9 for multicomponent items 4.

Multicomponent items means items consisting of a variety of components assembled with one another to form the final multicomponent item.

In particular, according to an example, the multicomponent item 4 is a hinge 4.

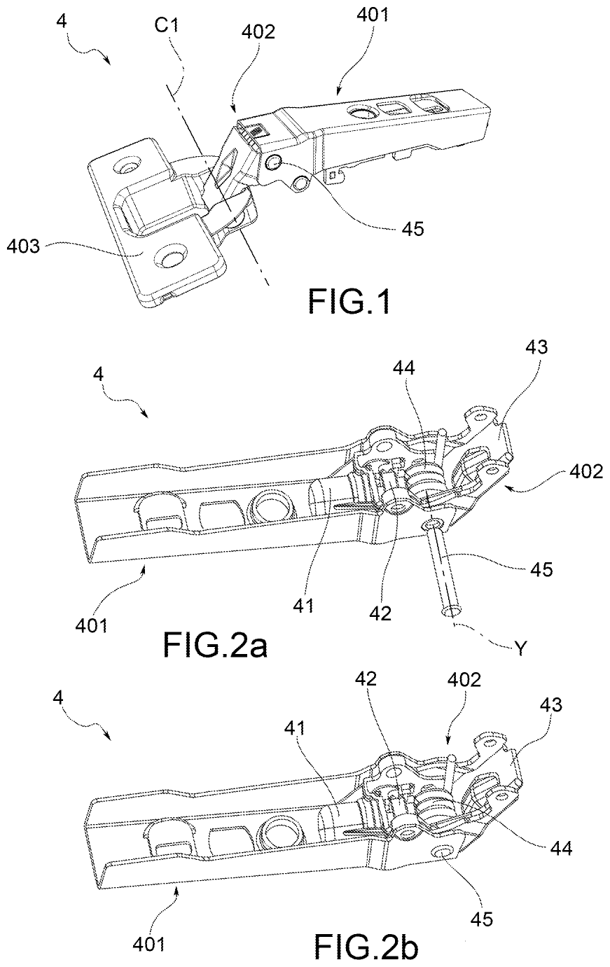

With reference to FIG. 1, the multicomponent item 4 is a hinge for furniture doors, according to a first example. Preferably, according to such an example, the multicomponent item 4 is a “slide-on” type of hinge.

The multicomponent item 4 is made at least by means of the assembly of a receiving component 401 and a joint assembly 402. In particular, a receiving seat 40 suitable for accommodating the joint assembly 402 is obtained in the receiving component 401.

Joint assembly 402 means an assembly formed by at least a first sub-assembly 412 and a second sub-assembly 434. Said first sub-assembly 412 comprises at least two components 41, 42, and said second sub-assembly 434 comprises one component 43 alone, or at least two components 43, 44.

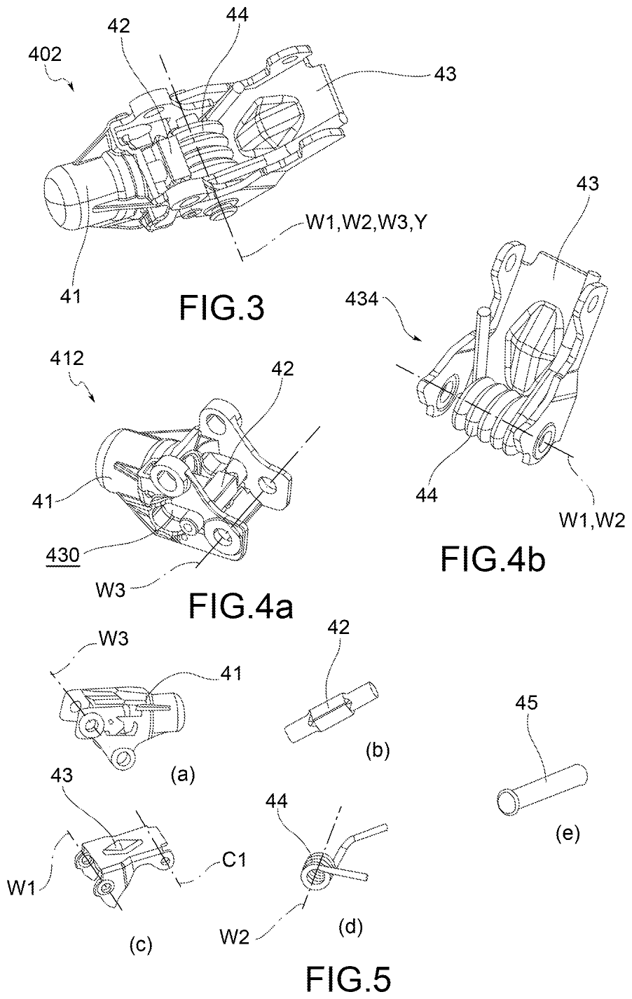

With reference to FIG. 3, in an embodiment, joint assembly 402 in the present disclosure means an assembly comprising a plurality of components 41, 42, 43, 44.

In a constructional variant, when assembled, the multicomponent item 4 also comprises one or more auxiliary components 403.

The present invention relates to a method for assembling two sub-assemblies 412, 434 to obtain a joint assembly 402 suitable for being then assembled to form a multicomponent item 4.

Said assembly method comprises the following operating steps:
a) providing a first sub-assembly 412 Comprising at least a first 41 and a second 42 component, and a second sub-assembly 434 comprising at least a third component 43;
b) by means of a first manipulator arm 1, picking the first sub-assembly 412 and keeping said sub-assembly 412 suspended, avoiding all contact with any support other than said first manipulator arm 1;
c) separately, by means of a second manipulator arm 2, picking the second sub-assembly 434 and keeping said second sub-assembly 434 suspended, avoiding all contact with any support other than said second manipulator arm 2;
d) moving at least one of said first sub-assembly 412 and said second sub-assembly 434 to bring said first and second sub-assemblies 412, 434 to a mutual assembly position, in which said first sub-assembly 412 is in an assembly position with said second sub-assembly 434;
e) assembling the first sub-assembly 412 with the second sub-assembly 434 in a suspended-in-air position to form a joint assembly 402, avoiding all contact with any support other than said first and second manipulator arms 1, 2.

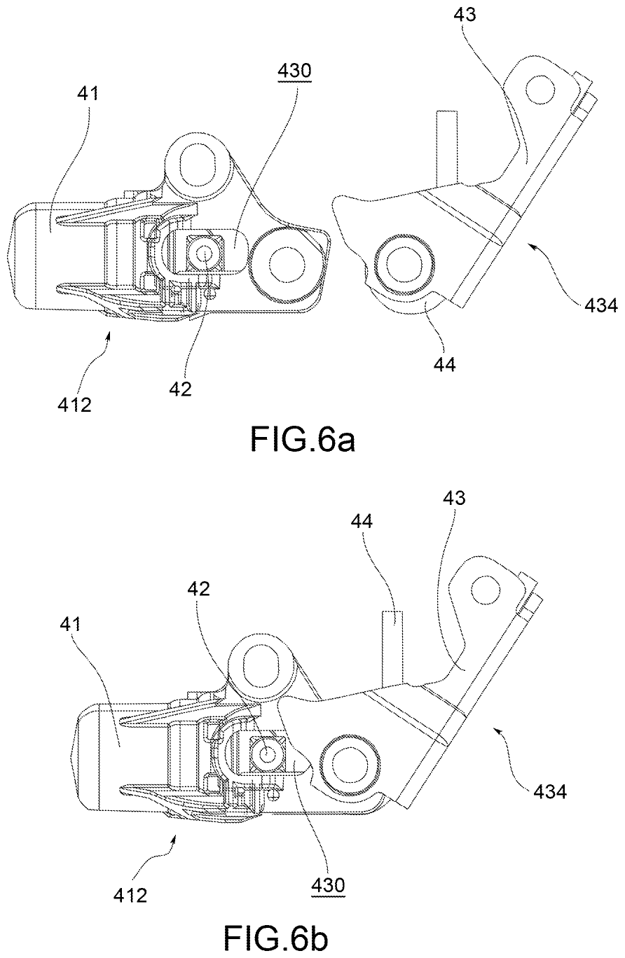

FIGS. 4a and 4b show said first and second sub-assemblies 412, 434, respectively, according to an embodiment of the invention. Moreover, in FIGS. 6a and 6b, said sub-assemblies are shown in an embodiment in mutual assembly and assembled position.

In an embodiment, the assembly method of the two sub-assemblies comprises, prior to step a), the following steps:
a0) providing a first pre-assembly group 91;
a1) assembling at least a first component 41 and a second component 42 to each other in the first pre-assembly group 91 to form the first sub-assembly 412.

In an embodiment, also the second sub-assembly 434 comprises at least two components 43, 44, and the method comprises, prior to step a), the following steps:
a01) providing a second pre-assembly group 92;
a11) assembling at least a third component 43 and a fourth component 44 to each other in the second pre-assembly group 92 to form the second sub-assembly 434.

In an advantageous constructional variant, the pre-assembly of the first sub-assembly 412 and the second sub-assembly 434 occurs simultaneously.

In an advantageous embodiment, steps a1) and a11) terminate simultaneously. I.e., according to such an embodiment, the first sub-assembly 412 and the second sub-assembly 434 become available for assembly to form the joint assembly 402 simultaneously.

In other words, the first pre-assembly group 91 is suitable for finishing the pre-assembly of said two or more components 41, 42, 43, 44 simultaneously to the second pre-assembly group 92. I.e., the first and second pre-assembly groups 91, 92 reach the end of the pre-assembly of the respective sub-assemblies 412, 434 together.

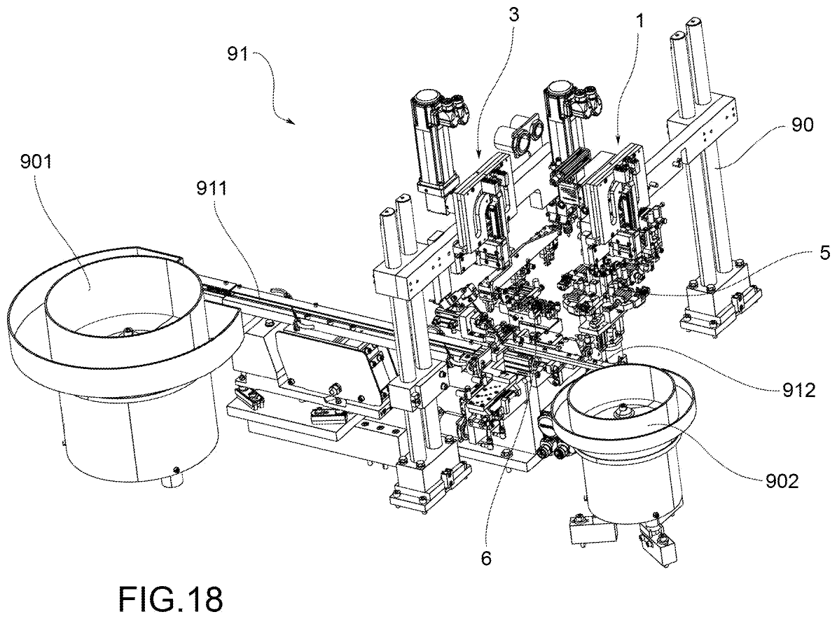

In an advantageous embodiment and with reference to FIGS. 18 to 20b, the first pre-assembly group 91 comprises a third manipulator arm 3 suitable for pre-assembling the first component 41 and the second component 42 to each other to form the first sub-assembly 412.

In a preferred embodiment, one or more of said first, second and third manipulator arms 1, 2, 3 are pick and place robots. For example, the structural and functional features of said first, second and third manipulator arms 1, 2, 3 are illustrated in documents WO2014/177985 and WO2014/177979 to the Applicant.

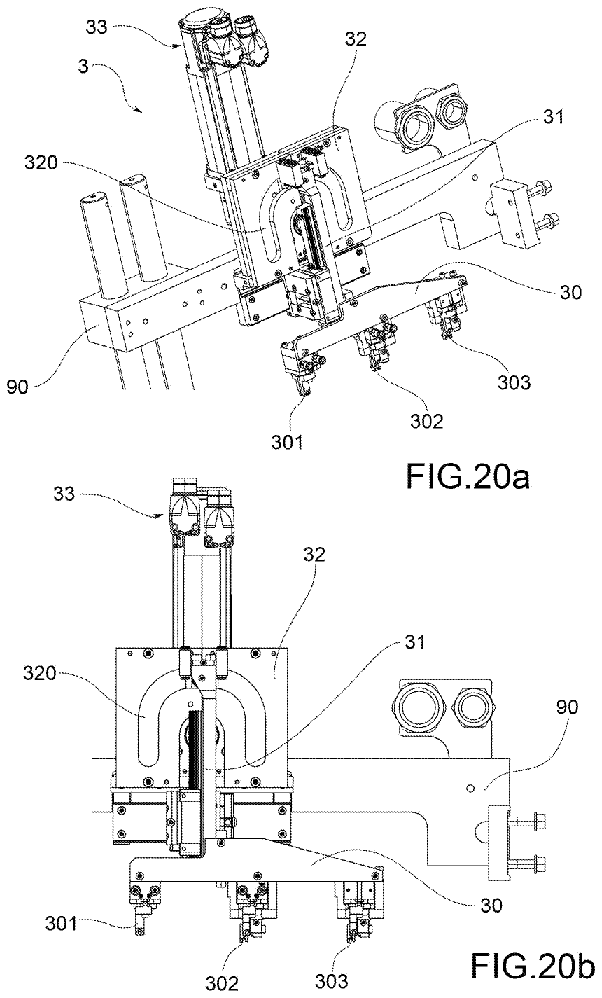

In a preferred embodiment and with reference to FIGS. 20a and 20b, the third manipulator arm 3 comprises a guiding wall 32 in which a guiding groove 320 is obtained. The third manipulator arm 3 further comprises an arm 31 and a gripper-holder group 30 sustained by said arm 31 and integral therewith.

In a particularly advantageous embodiment, the gripper-holder group of the third manipulator arm sustains three grippers, i.e., the first gripper 301, a second gripper 302, and a third gripper 303.

In such an embodiment, step a1) of the method for assembling two sub-assemblies comprises the following sub-steps:
m) by means of the first gripper 301, picking said first component 41 and bringing it to a second component insertion zone;
n) assembling said second component 42 with said first component 41 in said second component insertion zone to form the first sub-assembly 412;
o) picking, by means of the second gripper 302, said first sub-assembly 412 and bringing it to a greasing station 6;
p) greasing said first sub-assembly 412 in said greasing station 6;
q) picking, by means of the third gripper 303, said greased first sub-assembly 412 from the greasing station 6 and bringing it to a standby station 50 to be picked by the first manipulator arm 1.

Advantageously, in such an embodiment, the third manipulator arm 3 is suitable for simultaneously performing three operations which contribute to assembling the first sub-assembly 412.

Indeed, in a preferred embodiment, the three grippers 301, 302, 303 move integrally with one another.

Therefore, in such an embodiment, the first gripper 301, the second gripper 302 and the third gripper 303 are suitable for simultaneously performing three separate operations in a single movement of the third manipulator arm 3, preferably in the movement of the third manipulator arm 3 in a single direction.

The movement of the third manipulator arm 3 in the direction opposite to said single direction is a return operation which brings the grippers 301, 302, 303 back to the position initially occupied thereby.

In an advantageous embodiment, the second manipulator arm 2 is suitable both for pre-assembling the third component 43 and the fourth component 44 to form the second sub-assembly 434, and for picking the second pre-assembled sub-assembly 434 and assembling it to the first sub-assembly 412, preferably by the method for assembling two sub-assemblies of the present invention.

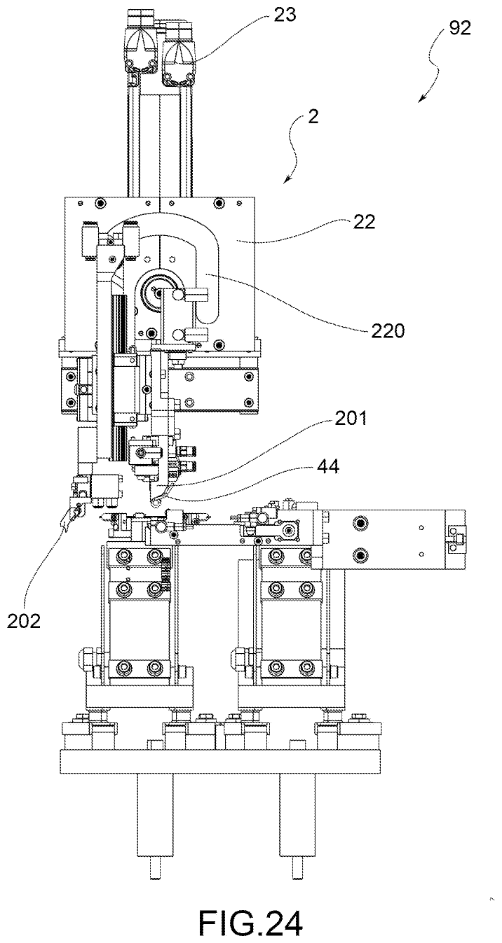

In a constructional variant and with reference to FIG. 24, the second manipulator arm 2 comprises a first gripper 201 suitable for being actuated to open and close so as to grab the fourth component 44 in the picking zone and transport it and position it in the third component 43.

Moreover, in a preferred embodiment, the second manipulator arm 2 comprises two grippers, i.e., the first gripper 201 described above, and a second gripper 202.

In an embodiment, the first gripper 201 and the second gripper 202 are not integral with each other during motion.

The second gripper 202 is suitable for picking the second sub-assembly 434 and assembling it together with the first sub-assembly 412, preferably by the method for assembling two sub-assemblies of the present invention.

Preferably, the first gripper 201 and the second gripper 202 of the second manipulator arm 2 are suitable for operating simultaneously on two consecutive second sub-assemblies 434. That is, the second gripper 202 is suitable for operating c a second sub-assembly 434 once pre-assembled by means of the first gripper 201.

The present invention also relates to a method for assembling multicomponent items 4 comprising a plurality of components 41, 42, 43, 44.

Such a method for assembling multicomponent items comprises the steps of the method for assembling two sub-assemblies according to the present invention, illustrated in the preceding paragraphs, and the following steps:
f) providing a grabbing device 70 suitable for receiving said previously assembled joint assembly 402;
g) bringing said joint assembly 402 from the suspended-in-air position to the grabbing device 70.

The grabbing device 70 preferably is a pallet 70 suitable for being moved along an assembly line in a feeding direction X, or a rotary table suitable for acting as a laying base.

For simplicity and intelligibility, in the continuation of the present description, reference will be made to the grabbing device 70 by the term pallet 70, but it is clear that the present disclosure also applies to the constructional variant in which the grabbing device 70 is a rotary table.

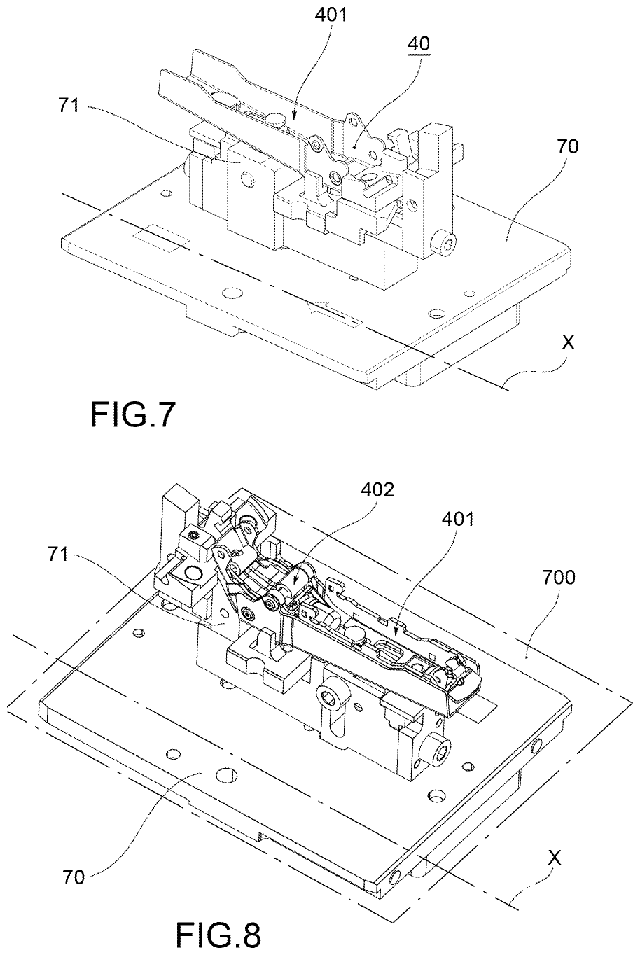

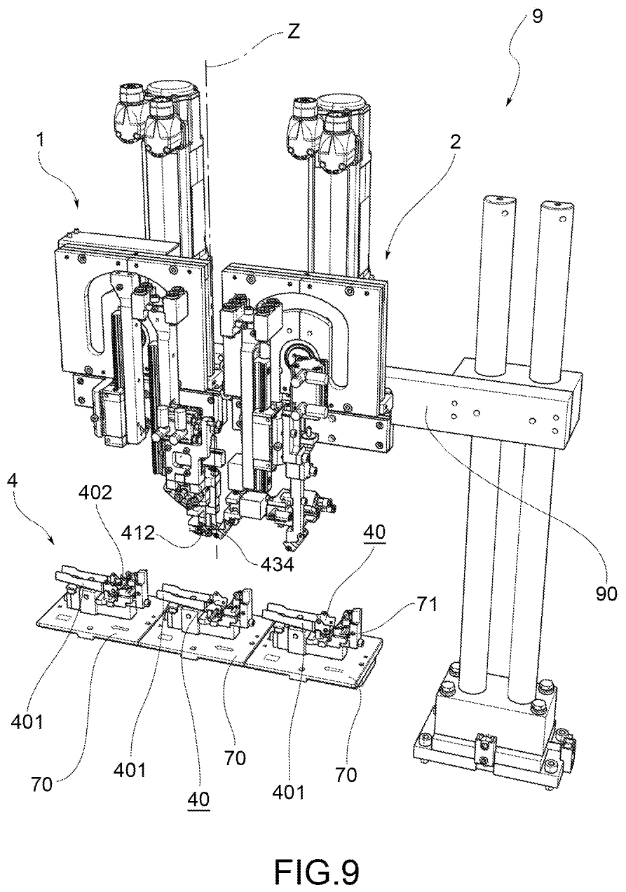

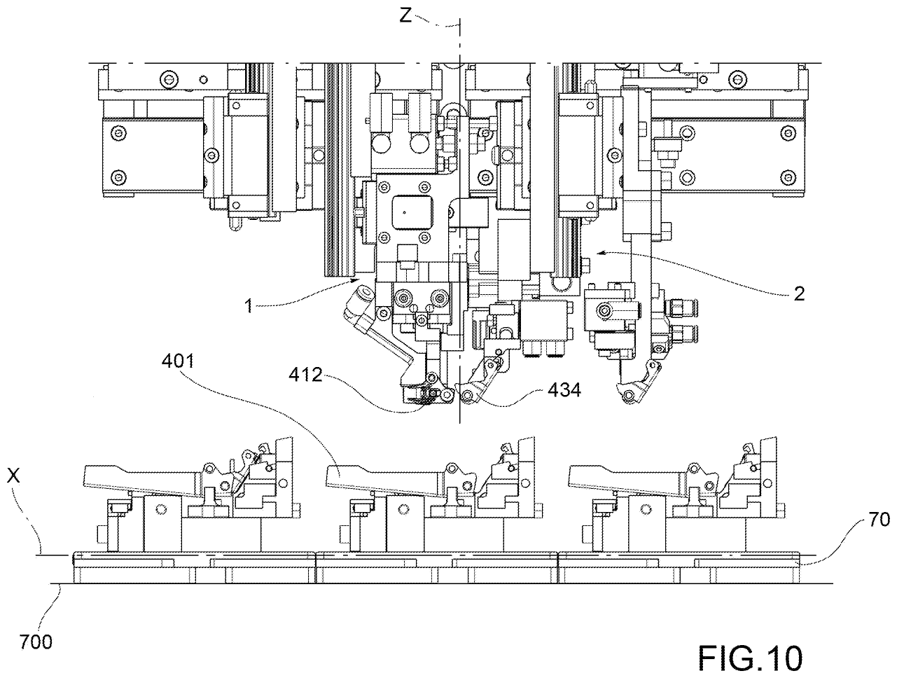

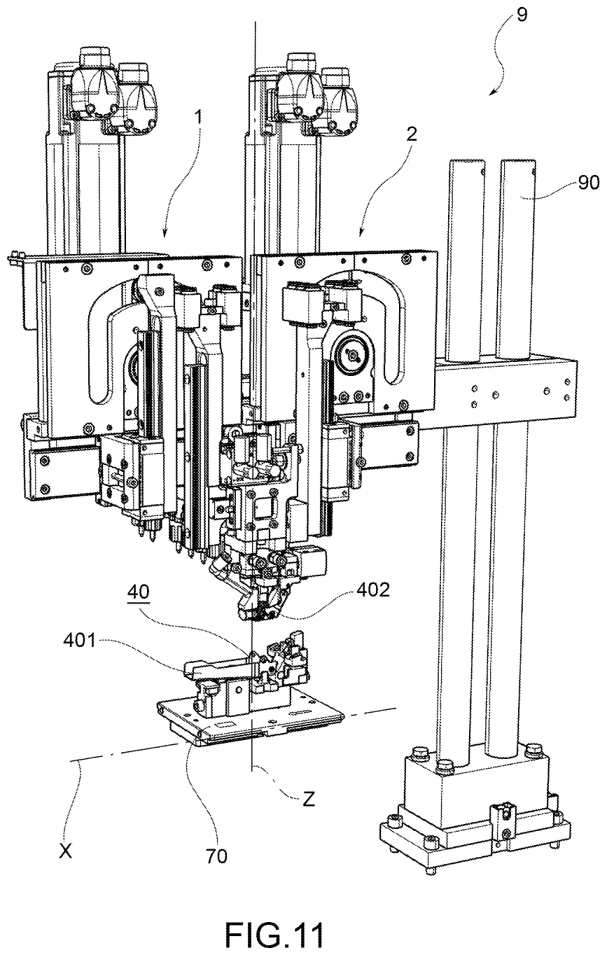

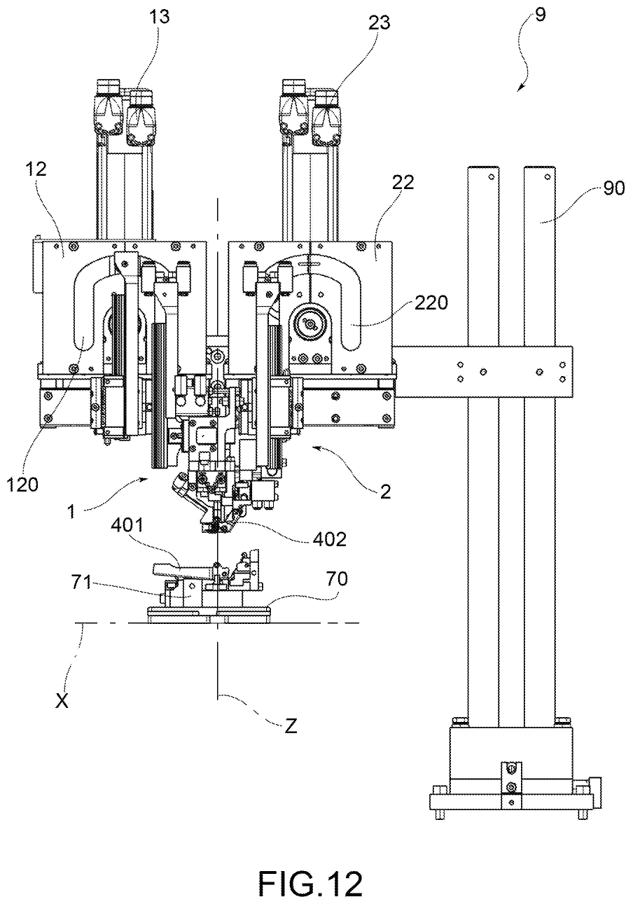

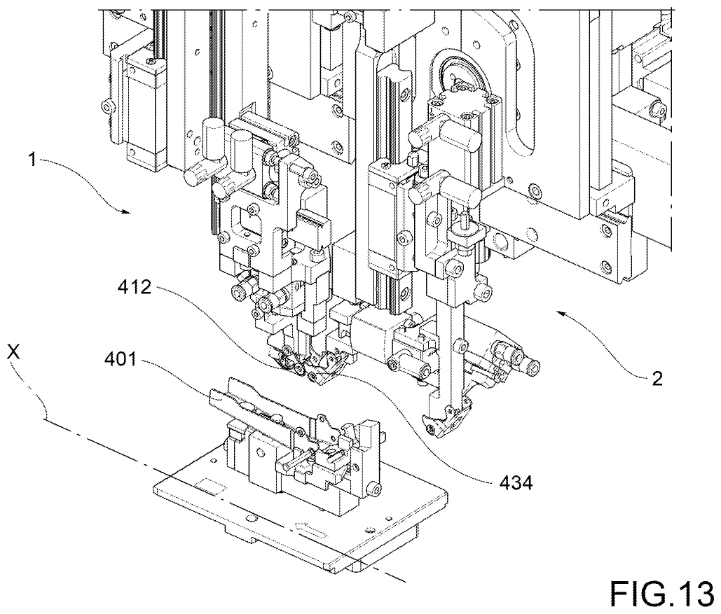

In an embodiment, with reference to the example in FIG. 7 or 8, pallet 70 preferably rests on a work surface 700, preferably parallel to the ground surface.

In the present disclosure, “ground surface” means an imaginary plane which identifies the base, ground or floor on which the assembly station is placed. “Ground surface” is the floor of a production site, for example.

Moreover, the grabbing device 70 preferably comprises a supporting seat 71 suitable for stably accommodating a receiving component 401 so that the receiving seat 40 faces upwards, i.e., faces the opposite side with respect to the work surface 700.

In an embodiment, the method for assembling two sub-assemblies and the method for assembling multicomponent items are performed in an assembly station 9.

Preferably, the assembly station 9 is inserted in an assembly line comprising a transport system for feeding the item in assembly to pallet 70 along a substantially straight feeding direction X substantially parallel to the work surface 700.

Therefore, according to such an embodiment, pallet 70 travels horizontally on an imaginary transport plane, parallel to the ground surface, taken as reference. The feeding direction X is thus contained within the imaginary transport plane.

In an embodiment, pallet 70 travels along said feeding direction X and stops on the work surface 700 of the assembly station 9, bringing the receiving component 401 to a stationary status, in which the receiving component 401 is available to the assembly station 9 and remains stationary and/or in the same assembly status during the steps of the method according to the invention.

In an embodiment, on said pallet 70 the receiving component 401 is positioned, comprising a receiving seat 40 suitable for accommodating as an assembly said joint assembly 402 previously assembled by the method for assembling two sub-assemblies of the present invention.

According to such an embodiment, step g) consists in bringing the joint assembly 402 from the suspended-in-air position to said receiving seat 40. Preferably, such a step g) is performed by means of the same first and second manipulator arms 1, 2.

In an advantageous embodiment, the first and second manipulator arms 1, 2 are suitable for being temporarily constrained to each other and for integrally performing a translation from the suspended-in-air position towards the receiving seat 40, and in which step g) is performed by means of the synchronous translation of each manipulator arm 1, 2 towards said receiving seat 40 so as to bring the joint assembly 402 towards the receiving component 401 and place it in said receiving seat.

In a particularly advantageous embodiment, with reference to the example in FIG. 7, the receiving component 401 is positioned on pallet 70 so that the receiving seat 40 faces the opposite side with respect to the ground surface.

In other words, in such an embodiment, the receiving component 401 lies on pallet 70, the receiving seat 40 facing upwards. Therefore, in such an embodiment, the receiving seat 40 is suitable for receiving a joint assembly 402 arriving from the top.

In an advantageous embodiment, the translation from the suspended-in-air position towards the receiving seat 40 occurs along a vertical direction Z, i.e., along a direction perpendicular to the work surface 700.

Therefore, according to such an advantageous embodiment, step g) is performed by means of the synchronous descent of each manipulator arm 1, 2 towards the receiving seat 40 so as to place the joint assembly 401 in said seat 40 from the top.

In an embodiment, the first manipulator arm 1 and the second manipulator arm 2 are suitable for engaging each other, e.g., by geometrical interlocking.

According to a further embodiment, a “master-slave” type control system is applied to said first and second manipulator arms 1, 2 so that, for example, when the second manipulator arm 2 is actuated in translation, also the first manipulator arm 1 is dragged in translation, or vice versa.

In an embodiment, step g) comprises the following sub-steps:
g1) by means of an electronic control unit, constraining the first 1 and second 2 manipulator arm to each other so as to make them integral in translation at least along said vertical direction Z;
g2) by means of the electronic control unit, moving at least one of said first 1 and second 2 manipulator arms in translation along said vertical direction Z towards the receiving seat 40.

In an embodiment, when assembled, the joint assembly 402 and the receiving component 401 form one or more rivet insertion seats suitable for accommodating one or more rivets 45 for connecting the joint assembly 402 in an articulated manner to the receiving component 401. According to such an embodiment, the assembly method comprises, after step
g), the following operating steps:
h) providing a riveting apparatus 8 close to pallet 70, comprising a riveting machine 81, and feeding said riveting apparatus 8 with one or more rivets 45;
i) hinging, by means of said riveting machine 81, the joint assembly 402 in the receiving component 401 by means of the insertion of said one or more rivets 45 in said one or more rivet insertion seats.

In a particularly advantageous preferred embodiment, all the steps listed occur while the receiving component 401 is in the same stationary status, i.e., all the steps occur while the receiving component 401 is in the same assembly status and/or in the same position.

This advantageously allows the assembly line to be shortened, concentrating a plurality of operations in a single position of the receiving component 401. Countless advantages result from such an aspect in terms of reducing overall plant volumes, increasing line productivity line, and in the production feeding speed.

Moreover, the method preferably comprises, prior to steps a0) and a01), the following component feeding step:
x) feeding the first pre-assembly group 91 and the second pre-assembly group 92 with the respective components 41, 42, 43, 44 by means of respective feeding devices 901, 902, 903, 904.

For clarity of disclosure and to favor the intelligibility of the present invention, the present invention will now be described in detail with reference to a hinge 4 and the components thereof. However, it is apparent that the present invention relates to an assembly station for a general multicomponent item consisting of components riveted to one another.

According to the example of a hinge 4, for example, with reference to accompanying FIGS. 1, 2a and 2b, the receiving component 401 is a wing 401 intended to be applied to the wall of a piece of furniture.

According to the example of hinge 4 and with reference to accompanying FIG. 3, the joint assembly 402 comprises the following components: a damper 41, a pin 42, preferably a square pin, a connecting rod 43 and a spring 44.

When accommodated in the receiving seat 40, the joint assembly 402 is hingeable, i.e., connectable in an articulated manner, to the receiving component 401 by means of the insertion of one or more rivets 45, as shown in FIGS. 2a and 2b, for example. The position of such one or more rivets 45 is illustrated in greater detail in the continuation of the present disclosure.

The components of the joint assembly 402 and a rivet 45 are each shown individually in FIG. 5 according to the constructional variant in which the multicomponent item is a hinge 4 of the “slide-on” type.

In particular, according to such a variant, damper 41, the connecting rod 43 and spring 44 each comprise a hole, each hole having a hole axis W1, W2, W3, respectively.

In assembly position, for example, as shown in FIG. 3, damper 41, the connecting rod 43 and spring 44 are positioned so that the respective hole axes W1, W2, W3 are aligned along a common alignment direction.

Similarly, wing 401 comprises a rivet hole having a rivet insertion axis Y.

In final assembly, for example, as shown in FIG. 2a, the components 41, 42, 43, 44 assembled to form the joint assembly 402 are inserted in the receiving seat 40 of wing 401 and the hole axes W1, W2, W3, previously aligned with one another in the assembly position, are also aligned with the rivet insertion axis Y. In other words, in final assembly, the above-mentioned alignment direction is aligned with the rivet insertion axis Y.

The joint assembly 402 is thus connectable in an articulated manner to wing 401 by means of the insertion of said at least one rivet 45 in said holes, previously aligned along the alignment direction, along said rivet insertion axis Y.

Moreover, in particular, damper 41 comprises a pin seat 430 suitable for accommodating pin 42.

Moreover, in an embodiment, the connecting rod 43 comprises a second hole having a hole axis C1, and hinge 4 comprises a box 403 suitable for engaging the connecting rod 43 through a locking means, e.g., a U-bolt, inserted along the hole axis C1.

In a particularly advantageous embodiment, with reference to the example of hinge 4 and to FIG. 7, wing 401 rests on pallet 70 so that the rivet insertion axis Y is parallel to the imaginary transport plane and is orthogonal to the feeding direction X, and so that the receiving seat 40 faces the opposite side with respect to the ground surface.

In other words, in such an embodiment, wing 401 lies horizontally on pallet 70 and the receiving seat 40 faces upwards. Therefore, in such an embodiment, the receiving seat 40 is suitable for receiving a joint assembly 402 arriving from the top.

The present invention relates to an assembly station 9 for assembling multicomponent items 4 starting from a first sub-assembly 412 and a second sub-assembly 434, and a receiving component 401, said assembly station 9 comprising:
a first manipulator arm 1 suitable for picking said first sub-assembly 412 from a respective picking zone and keeping it suspended, avoiding all contact with any support other than said first manipulator arm 1;
a second manipulator arm 2 suitable for picking said second sub-assembly 434 from a respective picking zone and keeping it suspended, avoiding all contact with any support other than said first manipulator arm 1;
a grabbing device 70 suitable for housing a receiving component 401 having a receiving seat 40 suitable for accommodating a joint assembly 402.

According to the invention, said first and second manipulator arms 1, 2 are suitable for assembling said sub-assemblies 412, 434 in a suspended-in-air position to form a joint assembly 402, avoiding all contact with any support other than said first and second manipulator arms 1, 2, and are suitable for bringing said joint assembly 402 from the suspended-in-air position to the receiving seat 40 of the receiving component 401.

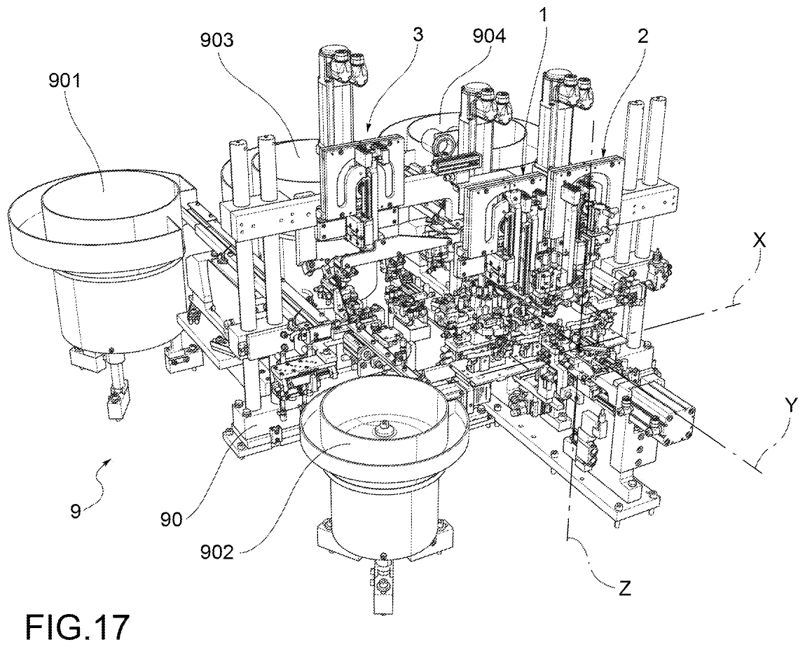

According to an aspect of the present invention, with reference to the examples in FIGS. 17, 18 and 23, an assembly station 9 for the multicomponent item 4, according to an embodiment, comprises a first pre-assembly group 91 and a second pre-assembly group 92. The first pre-assembly group 91 is suitable for pre-assembling the first sub-assembly 412 and the second pre-assembly group 92 is suitable for pre-assembling the second sub-assembly 434.

Moreover, in an embodiment, the assembly station 9 comprises a plurality of feeding devices 901, 902, 903, 904 for feeding the respective pre-assembly groups 91, 92 with the components 41, 42, 43, 44.

Preferably, such feeding devices 901, 902, 903, 904 are circular or linear electromagnetic vibration self-distributors.

Moreover, the assembly station 9 preferably comprises a support structure 90 which supports each pre-assembly group 91, 92 and each feeding device 901, 902, 903, 904.

Preferably, with reference to the example of hinge 4, the first pre-assembly group 91 is fed with a damper 41 and with a pin 42 by a damper feeding device 901 and a pin feeding device 902, respectively.

To this end, the first pre-assembly group 91 is suitable for manipulating damper 41 and pin 42, which are fed separately, so as to assemble pin 42 in damper 41.

In an advantageous embodiment, the feeding devices 901 and 902 are each followed by a transport guide 911, 912. Each transport guide 911, 912 is suitable for bringing the respective component 41, 42 to a respective picking zone.

In an advantageous embodiment, with reference to the example of hinge 4 and as shown in the examples in FIGS. 18 to 20b, the first pre-assembly group 91 comprises a third manipulator arm 3 suitable for applying pin 42 to damper 41.

In a preferred embodiment, said third manipulator arm 3 is a pick and place robot. For example, the structural and functional features of the third manipulator arm 3 are illustrated in documents WO2014/177985 and WO2014/177979 to the Applicant.

In a preferred embodiment, the third manipulator arm 3 is suitable for picking a first component 41, e.g., a damper 41, from the picking zone and bringing it to a second component insertion zone or pin insertion zone.

In a preferred feeding embodiment, the first pre-assembly group 91 comprises a position sensor suitable for detecting the presence of the first component 41 in the picking zone and suitable for sending a presence signal to an electronic control unit for actuating the third manipulator arm 3.

Preferably, the third manipulator arm 3 comprises a first gripper 301, sustained by a gripper-holder group 30. In an embodiment, such a first gripper 301 is suitable for being actuated to open and close so as to grab damper 41 in the loading zone and transport it in such a pin insertion zone.

Further, the first pre-assembly group 91 comprises a pin insertion device which inserts pin 42 into the pin seat 430.

Preferably, the pin insertion device is an unpacking device.

In an embodiment, the pin insertion device comprises a centering device and an inserter. The centering device comprises a respective movable punch suitable for positioning the damper 41 so that the pin seat 430 is suitable for receiving the pin 42. Such a movable punch is moved by a pneumatic cylinder. The inserter comprises a respective movable punch suitable for pushing the pin 42 into the pin seat 430.

In particular, when the movable inserter punch advances towards the pin seat 430, the movable centering device punch retracts progressively.

In a constructional variant, the pin insertion device advantageously comprises a linear transducer, e.g., a Sick transducer, suitable for measuring the exact position of the pneumatic cylinder moving the movable centering device punch.

Advantageously, such a linear transducer allows monitoring if the stroke of the pneumatic cylinder moving the centering device has actually been completed and ensuring that pin 42 is actually inserted in the pin seat 430.

According to an embodiment, as mentioned in the paragraphs above and with reference to FIGS. 20a and 20b, the third manipulator arm 3 comprises a first gripper 301, a second gripper 302 and a third gripper 303. The operation of the three grippers is detailed below with reference to the example in which the first component is a damper 41 and the second component is a pin 42.

In particular, the first gripper 301 is suitable for transporting damper 41 from a picking zone to a pin insertion zone, where a pin insertion device is suitable for inserting pin 42 into the pin seat 430. Preferably, pin 42 is fed by means of the aforesaid dedicated feeding device 902.

The second gripper 302 is suitable for picking the first sub-assembly 412, comprising damper 41 and pin 42 which are joined by means of the operation described in the preceding paragraph, from the pin insertion zone and bringing it to a first greasing station 6.

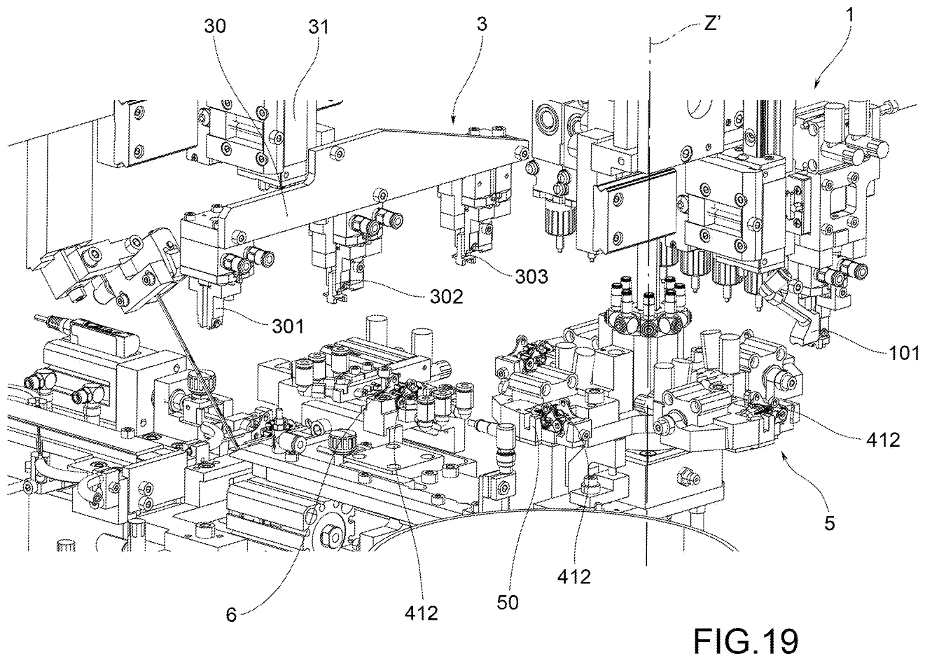

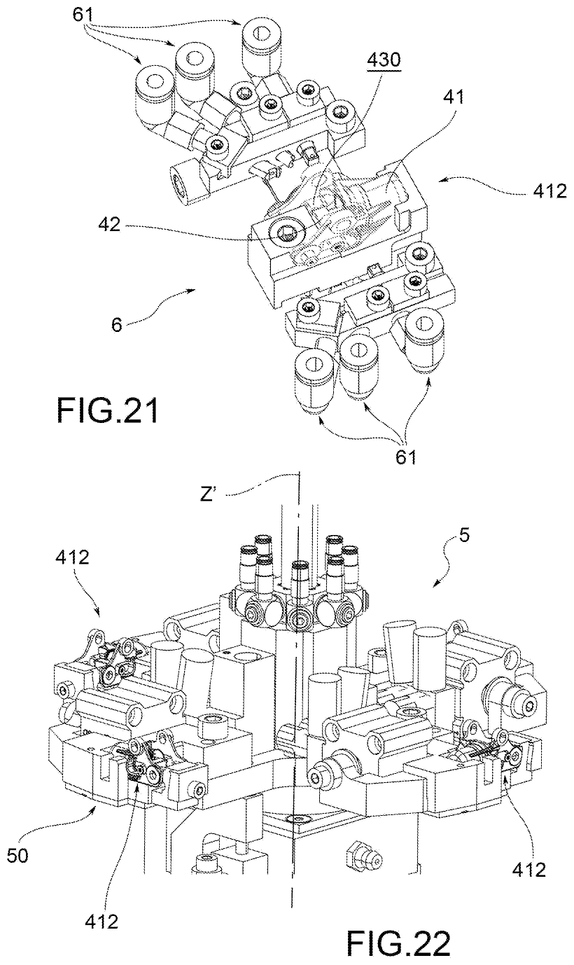

Therefore, according to an embodiment, as shown in FIGS. 18 and 19, the first pre-assembly group 91 comprises a greasing station 6. According to a constructional variant, for example, shown in FIG. 21, the greasing station 6 comprises greasing means 61 suitable for distributing grease in the pin seat 430.

Preferably, the greasing station 6 comprises a displacement pump suitable for dosing the grease. Moreover, in a constructional variant, such a displacement pump comprises a sensor suitable for detecting the presence of available grease, and an electronic control unit connected to such a sensor is suitable for actuating the pump only if such a sensor detects the availability of grease.

Lastly, the third gripper 303 is suitable for picking the first sub-assembly 412 from the greasing station 6 and bringing it to a standby station 50.

In an embodiment of the invention, as shown in FIGS. 18 and 19, the assembly station 9 comprises a rotary table 5, shown in detail in FIG. 22, comprising a supporting plate having two or more subsequent resting positions. Preferably, the standby station 50 is one position of said subsequent resting positions.

In other words, according to such an embodiment, the third gripper 303 is suitable for positioning the first sub-assembly 412 in one position of said subsequent positions of said rotary table 5, preferably in the position corresponding to the standby station 50.

In an embodiment, the rotary table 5 has four subsequent positions.

In a constructional variant, each subsequent position is suitable for receiving and supporting the first sub-assembly 412.

According to an advantageous embodiment, the rotary table 5 is rotationally operable about a second vertical direction Z′, parallel to the vertical direction Z and perpendicular to the ground surface.

In an advantageous embodiment, the rotary table 5 is suitable for being stopped during the rotation so that each subsequent position becomes, during the rotation, a standby station 50 for receiving the first sub-assembly 412.

According to an embodiment of the present invention, the first sub-assembly 412 is placed in the standby station 50 and the rotary table 5 performs two subsequent 90° rotations or one 180° rotation about the rotation axis Z, bringing the first sub-assembly 412 to a loading position.

In a variant of the invention, each subsequent position of the rotary table 5 comprises compression means suitable for compressing the damper 41.

Preferably, such compression means are pneumatic cylinders.

Advantageously, the positioning of the first sub-assembly 412 on the rotary table 5 allows a zone to be obtained which acts as a standby zone for providing said first sub-assembly 412 for picking by the first manipulator arm 1, for assembling it together with a second sub-assembly 434 by the method for assembling two sub-assemblies of the present invention and already described above.

Moreover, leaving the first sub-assembly 412 on the rotary table 5 advantageously allows damper 41 to be gradually compressed to be picked by the first manipulator arm 1.

Advantageously, the use of such a rotary table 5 allows the damper to be compressed gradually, avoiding possible breaking which could occur if the damper were compressed in an instantaneous manner.

Simultaneously, the stabilization of the grease deposited in the greasing station inside the pin seat 430 is advantageously promoted.

It is apparent that the three grippers 301, 302, 303 operate in series on the same first sub-assembly 412 and on the components thereof, i.e., on said first and second components 41, 42 (according to the example of hinge 4, on damper 41 and on pin 42), i.e., each gripper sequentially operates on the same sub-assembly.

It is just as apparent that while the first gripper 301 is operating on a first sub-assembly, the second gripper 302 is operating on a first preceding sub-assembly, i.e., on a first sub-assembly preceding it in the assembly line and which already underwent the insertion of pin 42 in the pin seat 430, and the third gripper 303 on a further preceding first sub-assembly, which already underwent the insertion of pin 42 in the pin seat 430 and the greasing of such a seat in the greasing station 6.

Accordingly, the three grippers 301, 302, 303 advantageously operate simultaneously on the separate sub-assemblies, thus increasing the productivity of the assembly station.

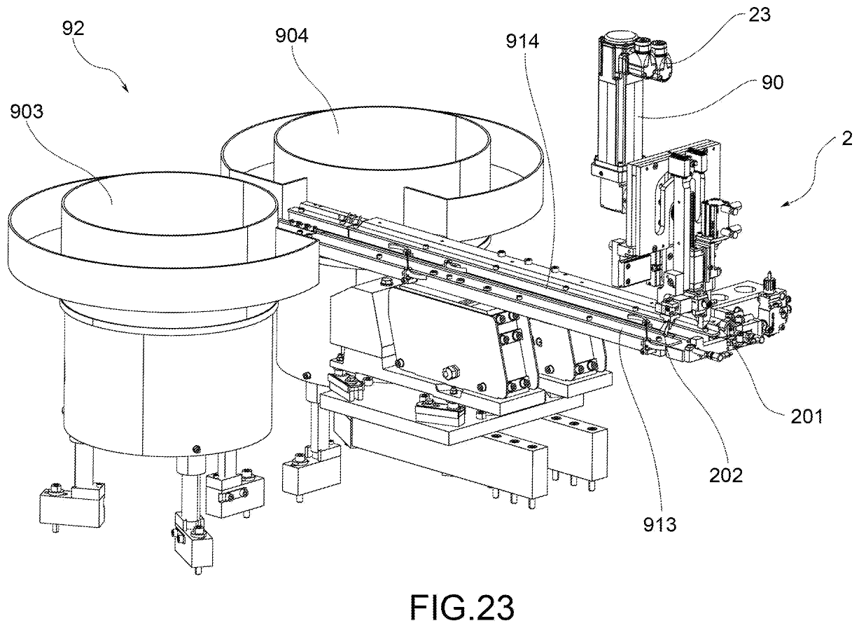

In an embodiment of the present invention, with reference to the example of hinge 4 and with reference to FIG. 4b, the second sub-assembly 434 comprises a connecting rod 43 and a spring 44. The second pre-assembly group 92 is suitable for pre-assembling said connecting rod 43 and said spring 44 to form the second sub-assembly 434. The second pre-assembly group 92 is shown according to an embodiment in FIGS. 23 and 24.

Preferably, the second pre-assembly group 92 is fed with each connecting rod 43 and with each spring 44 by a connecting rod feeding device 903 and a spring feeding device 904, respectively.

To this end, the second pre-assembly group 92 is suitable for handling the connecting rod 43 and spring 44 so as to assemble spring 44 in the connecting rod 43 to form the second sub-assembly 434.

In an embodiment, the feeding devices 903 and 904 are followed by a respective transport guide 913, 914, each transport guide 913, 914 being suitable for bringing the respective component 43, 44 to a respective picking zone.

In a variant, the second pre-assembly group 92 further comprises a respective greasing station for distributing grease in spring 44, preferably placed in the picking zone of the spring itself.

In an advantageous embodiment, the second manipulator arm 2 is suitable for both applying spring 44 to the connecting rod 43 and for picking the second pre-assembled sub-assembly 434 and assembling it together with the first sub-assembly 412, preferably by the method for assembling two sub-assemblies of the present invention.

In a preferred embodiment, in particular, the second manipulator arm 2 is suitable for picking a spring 44 from the picking zone and placing it in the connecting rod 43.

In a constructional variant, the second manipulator arm 2 comprises a first gripper 201 suitable for being actuated to open and close so as to grab the spring 44 in the picking zone and transport it and position it in the connecting rod 43.

Moreover, in a preferred embodiment, the second manipulator arm 2 comprises two grippers, i.e., the first gripper 201 described above, and a second gripper 202.

In an embodiment, the first gripper 201 and the second gripper 202 are not integral with each other during motion.

As illustrated above, the first gripper 201 is suitable for picking spring 44 and positioning it in the connecting rod 43.

As already mentioned for the general embodiment with respect to a third component 43 and a fourth component 44, the second gripper 202 is suitable for picking the second sub-assembly 434 and assembling it together with the first sub-assembly 412, preferably by the method for assembling two sub-assemblies of the present invention.

Preferably, the two grippers 201 and 202 are suitable for acting simultaneously on two consecutive sub-assemblies 434. It is apparent that each gripper 201, 202 operates on the same second sub-assembly 434 and/or on the components 43, 44 thereof, i.e., in such an embodiment, on the connecting rod 43 and on spring 44, in series.

Moreover, in an advantageous embodiment, the first manipulator arm 1 is suitable for picking the first sub-assembly 412 from the rotary table 5.

In a constructional variant, the first manipulator arm 1 comprises a gripper 101 suitable for opening and closing to grab the first sub-assembly 412 to bring it to the suspended position and assemble it together with a second sub-assembly 434, preferably by the method for assembling two sub-assemblies according to the present invention.

In a preferred embodiment, each manipulator arm 1, 2, 3 comprises a guiding wall 12, 22, 32 in which a guiding groove 120, 220, 320 is obtained. Each guiding groove is suitable for guiding the movement of a respective gripper according to the functionalities described in the aforesaid documents.

Moreover, each manipulator arm 1, 2, 3 preferably comprises at least one gripper 101, 201, 301.

In an advantageous embodiment, the first manipulator arm 1 and the second manipulator arm 2 are suitable for picking the first sub-assembly 412 and the second sub-assembly 434, respectively, and keeping them suspended, avoiding all contact with any support other than said first 1 and second 2 manipulator arm in a same final assembly zone.

In an advantageous variant, the first manipulator arm 1 and the second manipulator arm 2 are suitable for assembling the first sub-assembly 412 and the second sub-assembly 434 to each other to obtain a joint assembly 402.

According to the present invention, said first and second manipulator arms 1, 2 are suitable for assembling such sub-assemblies 412, 434 in a suspended-in-air position, i.e., “flying”, that is, avoiding all contact with any support other than said first and second manipulator arms 1, 2, to form a joint assembly 402.

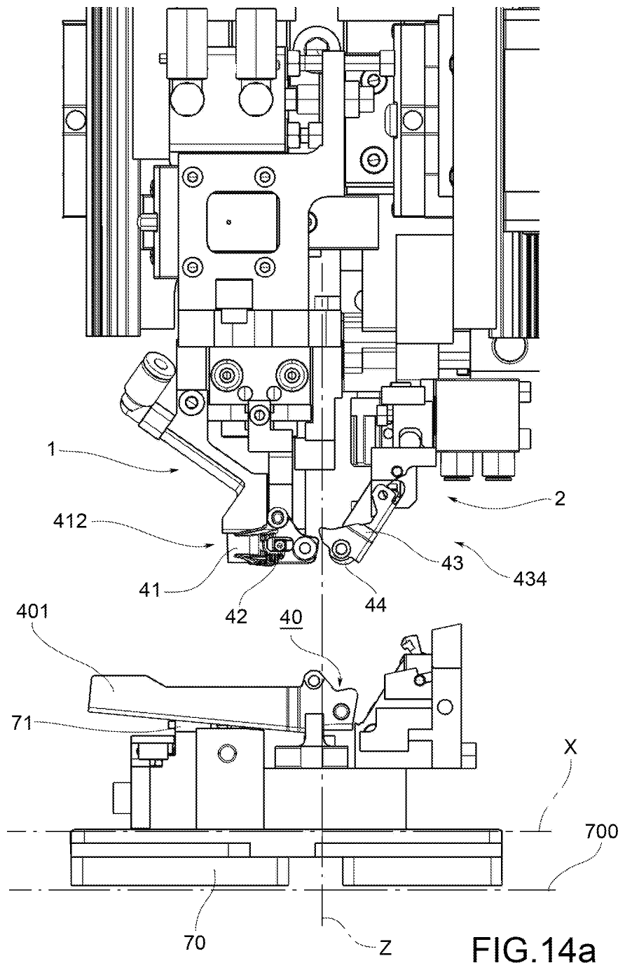

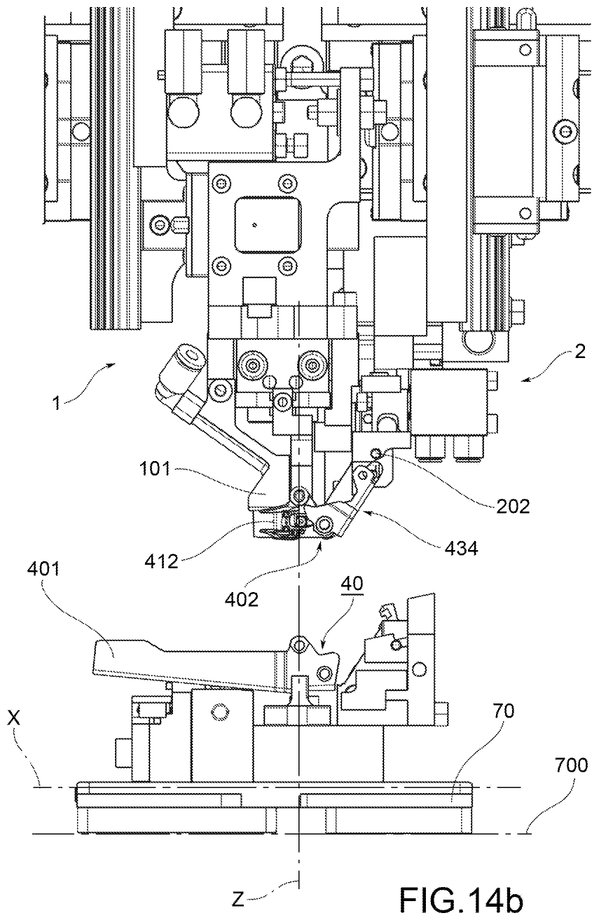

In an embodiment, for example, as shown in FIGS. 14a and 14b, considering the receiving component 401 (according to the example of the hinge, wing 401) placed on pallet 70, the assembly of the sub-assemblies described above occurs at a given distance along the vertical direction Z from said receiving component 401.

Preferably, the receiving seat 40 accommodates the sub-assemblies only once they have been assembled in the air, at a given distance from said seat 40.

Moreover, according to an advantageous embodiment, following the assembly in suspended position of the joint assembly 402, the first manipulator arm 1 and the second manipulator arm 2 are suitable for translating towards the receiving component 401, dragging with them the joint assembly 402 previously assembled in the air, to position it in the receiving seat 40.

Preferably, said first and second manipulator arms 1, 2 are suitable for translating towards the receiving seat 40 along the vertical direction Z.

In a preferred embodiment, the first manipulator arm 1 and the second manipulator arm 2 are suitable for moving integrally along the vertical direction Z to translate the joint assembly 402 vertically towards the receiving seat 40 of the receiving component 401.

It is apparent that, as described at the beginning of the present disclosure, in the example of hinge 4, the joint assembly 402 is arranged in the receiving seat 40 so that the respective hole axes W1, W2, W3 of damper 41, of the connecting rod 43 and of spring 44, are aligned with the rivet insertion axis Y of the hole of wing 401.

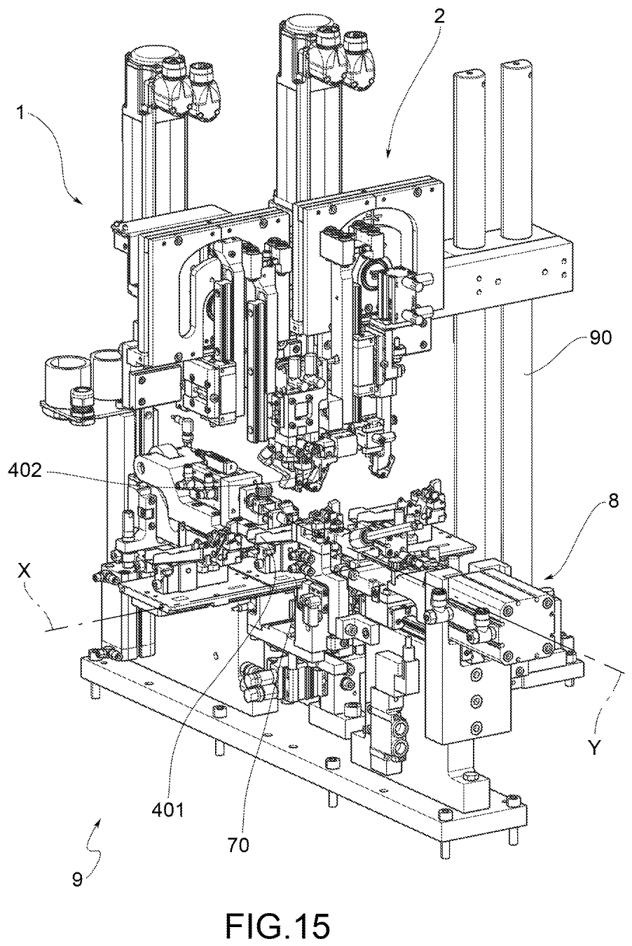

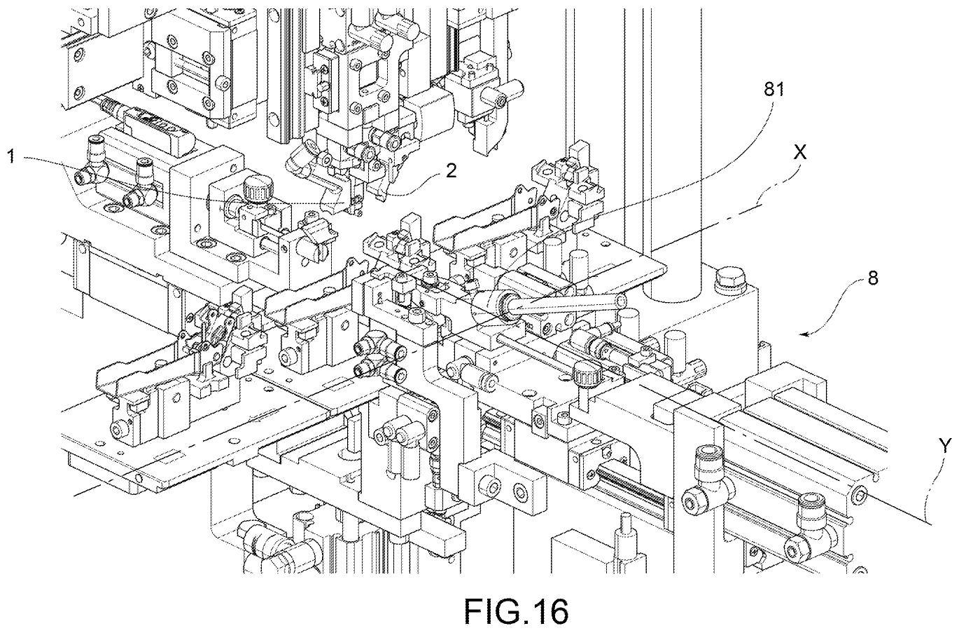

In an embodiment of the present invention and with reference to the embodiment depicted in FIGS. 15 and 16, the assembly station 9 further comprises a riveting apparatus 8 comprising a riveting machine 81.

In a preferred variant, the riveting apparatus 8 is placed close to the grabbing system, for example, close to pallet 70, and in particular, the riveting machine 81 is arranged, with respect to wing 401, in an aligned manner with respect to the rivet insertion axis Y.

Preferably, the riveting apparatus 8 has the same structural and functional features illustrated in documents WO2018/029563 and WO2020/121102A1 to the Applicant.

The riveting machine 81 is suitable for inserting rivet 45 in wing 401 and in the joint assembly 402 along the rivet insertion axis Y so as to connect the joint assembly 402 and wing 401 in an articulated manner.

In an embodiment of the invention, the assembly station 9 comprises detection means suitable for detecting a station status and transmitting a working signal or a stationary signal to the electronic control unit to stop or actuate, respectively, the assembly station 9.

In particular, such detection means comprise a first sensor suitable for detecting the presence of a provision of components along each transport guide 911, 912, 913, 914.

Moreover, preferably such detection means comprise a second sensor suitable for detecting if the provision of components along each transport guide 911, 912, 913, 914 is sufficient to push the respective component to the correct position in the loading zone to be picked by the respective manipulator arm.

Moreover, in an embodiment, the detection means comprise a third sensor, preferably placed at an end of one or more of the transport guides 911, 912, 913, 914, said sensor being suitable for detecting the presence, in the respective picking zone c, of the component which is to be picked by the respective manipulator arm.

In the most complete embodiment, the method for assembling multicomponent items according to the embodiment in which the multicomponent item 4 is a hinge, consists of the following steps:
I) providing an assembly station 9 according to the present invention;
II) feeding a first pre-assembly group 91 with a damper 41 and a pin 42, and feeding a second pre-assembly group 92 with a connecting rod 43 and a spring 44;
III) in the first pre-assembly group 91, assembling damper 41 and pin 42 to each other to form a first sub-assembly 412;
IV) in the second pre-assembly group 92, assembling the connecting rod 43 and spring 44 to each other to form a second sub-assembly 434;
V) by means of a first manipulator arm 1 and a second manipulator arm 2, bringing the first sub-assembly 412 and the second sub-assembly 434, respectively, to a suspended-in-air position;
VI) in said suspended-in-air position, assembling the first sub-assembly 412 with the second sub-assembly 434 to form a joint assembly 402;
VII) providing a pallet 70 on which a wing 401 is positioned comprising a receiving seat 40 suitable for accommodating the joint assembly 402;
VIII) bringing the joint assembly 402 to the receiving seat 40 so as to form one r more rivet insertion seats suitable for engaging one or more rivets 45;
IX) providing a riveting apparatus 8 close to pallet 70 having wing 401 in stationary status, said riveting apparatus& comprising a riveting machine 81, and feeding said riveting apparatus 8 with one or more rivets 45;
X) connecting, by means of the riveting machine 81, the joint assembly 402 and wing 401 in an articulated manner by means of the insertion of said one or more rivets 45 in said one or more rivet insertion seats in the joint assembly 402 and in wing 401.

Preferably, steps I) to X) of the method occur all in a same assembly station 9 and while the receiving component 401 on pallet 70 is in a single stationary status.

In an embodiment, when the assembly station 9 is inserted in an assembly line, pallet 70 is actuated in translation along the feeding direction X only once wing 401 has been connected in an articulated manner with the joint assembly 402 by means of the insertion of one or more rivets 45.

The present invention also relates to an assembly line comprising an assembly station 9 according to the present invention.

Innovatively, the present invention solves the conventional drawbacks of the background art.

Advantageously, the assembly station according to the present invention allows the assembly operations of a multicomponent item to be accelerated.

Moreover, advantageously the assembly station, the assembly method and the assembly line according to the present invention simplify the assembly operations of a multicomponent item and ensure an increase in the production volumes of the assembly line in which they are inserted with respect to known assembly lines, time being equal.

According to a further advantage, the assembly station according to the present invention increases the flexibility of the assembly line in which it is inserted. Indeed, advantageously, providing an assembly station suitable for allowing assembling a plurality of accessory components in a single station allows adapting the assembly line to constructional variants of the final multicomponent item, intervening only on the sub-steps of the assembly, without acting on the development of the main line.

It is apparent that in order to meet specific needs, those skilled in the art could make variations to the embodiments of the aforesaid assembly station or replace elements with others which are functionally equivalent.

Such variations are also contained within the scope of protection as defined by the following claims. Moreover, each variation described as belonging to a possible embodiment can be implemented irrespective of the other variations described.

What is claimed is:

1. A method for assembling two sub-assemblies for obtaining a joint assembly suitable for being assembled for making a multicomponent item, the method comprising the following steps:
a) providing a first sub-assembly comprising at least a first component and a second component and a second sub-assembly comprising at least a third component;
b) by a first manipulator arm, picking the first sub-assembly and keeping said first sub-assembly suspended, avoiding all contact with any support other than said first manipulator arm;
c) separately, by a second manipulator arm, picking the second sub-assembly and keeping said second sub-assembly suspended, avoiding all contact with any support other than said second manipulator arm;
d) moving at least one of said first sub-assembly and said second sub-assembly to bring said first and second sub-assemblies to a mutual assembly position, wherein said first sub-assembly is in an assembly position with said second sub-assembly; and
e) assembling the first sub-assembly with the second sub-assembly in a suspended-in-air position for forming the joint assembly, avoiding all contact with any support other than said first and second manipulator arms.

2. The method of claim 1, comprising, prior to step a), the following steps:
a0) providing a first pre-assembly group; and
a1) assembling said first component and said second component to each other in the first pre-assembly group for forming the first sub-assembly.

3. The method of claim 1, wherein the second sub-assembly comprises at least two components, and wherein the method comprises, prior to step a), the following steps:
a01) providing a second pre-assembly group; and
a11) assembling the third component and a fourth component to each other in the second pre-assembly group for forming the second sub-assembly.

4. The method of claim 2, wherein the second sub-assembly comprises at least two components, and wherein the method comprises, prior to step a), the following steps:
a01) providing a second pre-assembly group; and
a11) assembling the third component and a fourth component to each other in the second pre-assembly group for forming the second sub-assembly, and
wherein steps a1) and a11) terminate simultaneously.

5. The method of claim 2, wherein the first pre-assembly group comprises a third manipulator arm comprising a first gripper, a second gripper and a third gripper, and wherein step a1) comprises the following sub-steps:
m) picking, by the first gripper, said first component and bringing said first component to a second component insertion zone;
n) assembling said second component with said first component in said second component insertion zone to form the first sub-assembly;
o) picking, by the second gripper, said first sub-assembly and bringing said first sub-assembly to a greasing station;
p) greasing said first sub-assembly in said greasing station; and
q) picking, by the third gripper, said greased first sub-assembly from the greasing station and bringing said greased first sub-assembly to a standby station to be picked by the first manipulator arm.

6. The method of claim 5, wherein the first gripper, the second gripper and the third gripper move integrally with one another.

7. A method for assembling multicomponent items comprising a plurality of components, the method comprising
a method for assembling two sub-assemblies for obtaining a joint assembly suitable for being assembled for making a multicomponent item, the method comprising:
a) providing a first sub-assembly comprising at least a first component and a second component and a second sub-assembly comprising at least a third component;
b) by a first manipulator arm, picking the first sub-assembly and keeping said first sub-assembly suspended, avoiding all contact with any support other than said first manipulator arm;
c) separately, by a second manipulator arm, picking the second sub-assembly and keeping said second sub-assembly suspended, avoiding all contact with any support other than said second manipulator arm;
d) moving at least one of said first sub-assembly and said second sub-assembly to bring said first and second sub-assemblies to a mutual assembly position, wherein said first sub-assembly is in an assembly position with said second sub-assembly; and
e) assembling the first sub-assembly with the second sub-assembly in a suspended-in-air position for forming the joint assembly, avoiding all contact with any support other than said first and second manipulator arms,
and the following steps:
f) providing a grabbing device suitable for receiving said previously assembled joint assembly; and
g) bringing said joint assembly from the suspended-in-air position to the grabbing device.

8. The method of claim 7, wherein a receiving component is positioned on the grabbing device, the receiving component comprising a receiving seat suitable for receiving in assembly said previously assembled joint assembly, and wherein step g) consists in bringing the joint assembly from the suspended-in-air position to said receiving seat.

9. The method of claim 8, wherein the first and second manipulator arms are suitable for being temporarily constrained to each other and for integrally translating towards the grabbing device and wherein step g) is performed by a synchronous translation of each manipulator arm towards said grabbing device so as to bring the joint assembly towards the receiving component and place the joint assembly in the receiving seat.

10. The method of claim 9, wherein the grabbing device is placed on a work surface parallel to a ground surface, wherein the translation of the first and second manipulator arms towards the grabbing device occurs at least along a vertical direction, perpendicular to said work surface, and wherein step g) is performed by a synchronous descent of each manipulator arm towards said grabbing device and the joint assembly is placed in the receiving seat from the top.

11. The method of claim 10, wherein step g) comprises the following sub-steps:
g1) by an electronic control unit, constraining the first and second manipulator arms to each other so as to make the first and second manipulator arms integral in translation at least along said vertical direction; and
g2) by the electronic control unit, moving at least one of said first and second manipulator arms in translation along said vertical direction towards the receiving seat.

12. The method of claim 8, wherein when assembled, the joint assembly and the receiving component form one or more rivet insertion seats suitable for receiving one or more rivets for connecting the joint assembly in articulated manner to the receiving component, and wherein the method comprises, after step g), the following operating steps:
h) providing a riveting apparatus in proximity of the grabbing device, comprising a riveting machine, and feeding said riveting apparatus with the one or more rivets; and
i) connecting, by said riveting machine, the joint assembly in articulated manner in the receiving component by inserting said one or more rivets in said one or more rivet insertion seats.

13. The method of claim 8, wherein all the steps occur while the receiving component is in a same stationary status, namely in a same assembly status and/or in a same position.

14. An assembly station for assembling multicomponent items starting from a first sub-assembly and a second sub-assembly, and a receiving component, said assembly station comprising:
a first manipulator arm suitable for picking said first sub-assembly from a respective picking zone and keeping the first sub-assembly suspended, avoiding all contact with any support other than said first manipulator arm;
a second manipulator arm suitable for picking said second sub-assembly from a respective picking zone and keeping the second sub-assembly suspended, avoiding all contact with any support other than said second manipulator arm; and
a grabbing device suitable for accommodating the receiving component, the receiving component comprising a receiving seat suitable for receiving a joint assembly;
said first and second manipulator arms being suitable for assembling said first and second sub-assemblies in a suspended-in-air position to form the joint assembly, avoiding all contact with any support other than said first and second manipulator arms, and being suitable for bringing said joint assembly from the suspended-in-air position to the receiving seat.

15. The assembly station of claim 14, further comprising a first pre-assembly group suitable for pre-assembling a first component and a second component for making the first sub-assembly, and a second pre-assembly group suitable for pre-assembling a third component and a fourth component for making the second sub-assembly.

16. The assembly station of claim 14, wherein when assembled, the joint assembly and the receiving component form one or more rivet insertion seats suitable for receiving one or more rivets, and wherein said assembly station further comprises a riveting apparatus comprising a riveting machine suitable for being fed with the one or more rivets and for connecting the joint assembly and the receiving component in articulated manner by inserting said one or more rivets in said one or more rivet insertion seats.

17. The assembly station of claim 15, wherein the first pre-assembly group comprises a third manipulator arm comprising a first gripper, a second gripper and a third gripper, said first, second and third grippers being suitable for simultaneously performing at least three operations which contribute to assembling the first sub-assembly, and for integrally moving with one another.

18. The assembly station of claim 15, wherein the second manipulator arm is also part of the second pre-assembly group and comprises a first gripper and a second gripper, wherein said first gripper is suitable for pre-assembling the third component and the fourth component to form the second sub-assembly, and wherein said second gripper is suitable for picking said second sub-assembly and assemble said second sub-assembly together with said first sub-assembly.

19. The assembly station of claim 18, wherein the first gripper and the second gripper are suitable for moving integrally with each other.

20. An assembly line comprising the assembly station of claim 14.
